(19) United States
(12) Patent Application Publication
(10) Pub. No.: US 2017/0169775 A1
(43) Pub. Date: Jun. 15, 2017

(54) DRIVING METHOD FOR A LIQUID CRYSTAL DISPLAY AND DEVICE OF THE SAME

(71) Applicant: Shenzhen China Star Optoelectronics Technology Co., Ltd., Shenzhen, Guangdong (CN)

(72) Inventors: Zhao WANG, Shenzhen, Guangdong (CN); Yu-Yeh CHEN, Shenzhen, Guangdong (CN); Yin-hung CHEN, Shenzhen, Guangdong (CN)

(73) Assignee: Shenzhen China Star Optoelectronics Technology Co., Ltd., Shenzhen, Guangdong (CN)

(21) Appl. No.: 15/034,813

(22) PCT Filed: Sep. 8, 2015
(86) PCT No.: PCT/CN2015/089148

§ 371 Date: May 5, 2016

(30) Foreign Application Priority Data
Jul. 29, 2015 (CN) 201510455854.3

(51) Int. Cl. G09G 3/36

(52) U.S. Cl. CPC G09G 3/3614; G09G 3/3648; G09G 2310/0297; G09G 2310/0218; G09G 2310/0243

(57) ABSTRACT

A photocoupler isolation switch circuit is disclosed. The circuit includes a power chip and a voltage driving chip including a photocoupler device having a light emitting device and a photosensitive device. A first output terminal of the power chip connects to a first terminal of the light emitting device, and a second terminal of the light emitting device connects to ground; a second output terminal of the power chip connects to a first terminal of the photosensitive device and outputs a driving voltage, a second terminal of the photosensitive device connects to an output terminal of the photocoupler device; the photocoupler device controls a working status of the light emitting device according to a control voltage, the photosensitive device is turned on or off according to the working status; the driving voltage is outputted through the output terminal of the photocoupler device when the light emitting device is turned on.

### CROSS REFERENCE

This application claims the priority of Chinese Patent Application No. 201510455854.3, entitled “Driving method for a liquid crystal display and device of the same”, filed on Jul. 29, 2015, the disclosure of which is incorporated herein by reference in its entirety.

### FIELD OF THE INVENTION

The present disclosure relates to an electric circuit technology field, and more particularly to a driving method for a liquid crystal display and a device of the same.

### BACKGROUND OF THE INVENTION

Currently, a thin-film transistor liquid crystal display (referred to: TFT-LCD) is widely applied on customer terminal such as note book, desktop computer, cell phone, or flat panel computer. In a driving process of the current TFT-LCD, a liquid crystal polarization phenomenon will generate, that is, when displaying a second frame image, a blur of a first frame image will exist. In order to avoid the phenomenon, a data driver uses a switching technology of a positive and negative polarity. That is, each sub-pixel is driven by voltages having different polarities in two adjacent frames so that the polarity of a liquid crystal capacitor is changed continuously in order to avoid the liquid crystal polarization phenomenon. Currently, in order to realize the above technology, a driving chip usually provides with one channel corresponding to one Digital to Analog Conversion circuit (referred to: DAC), and provides with two adjacent channels corresponding to DAC circuits having opposite polarities. For example, channel 1 provides with +DAC, and channel 2 provides with −DAC. In a multiplexer different data connection modes are provided. Wherein, controlling mode control signal can control the data connection modes. The data in channels can base on the data connection modes of the multiplexer, and through in phase DAC or reverse phase DAC to realize outputting alternating polarity data in multiple channels. That is, the output polarities are “+−+−+− . . . ”.

However, along with the development of the display technology, more requirements for the output polarities are existed. For example, when the output polarities of the multiple channels are “++++−−−−++++−−−− . . . ”, if changing the circuit design of current data driver to realize the above output polarities, the cost is high. Besides, because a size of the current data driver is very small, it is very difficult to add a new module to realize the above output polarities. The output polarities of current data driver are monotonous, which cannot satisfy the requirement of multi-polarity output.

### SUMMARY OF THE INVENTION

The embodiment of the present disclosure provides a driving method and a device for a liquid crystal display, and the present disclosure can output multiple polarity patterns to satisfy the requirement of multiple polarity output.

On one hand, the embodiment of the present disclosure provides a driving method for a liquid crystal display, the method incudes following steps:

detecting a mode control signal;

when the mode control signal is detected as a high voltage signal, building a first signal transmission channel group including N signal transmission channels for N image signals inputting to N input terminals of a driving device of a liquid crystal display, using the first signal transmission channel group to transmit the N image signals to the liquid crystal panel in order to display a first polarity pattern on the display panel, and N is an integer greater than 1;

when the mode control signal is detected as a low voltage signal, building a second signal transmission channel group including N signal transmission channels for the N image signals inputting to the N input terminals of the driving device of the liquid crystal display, using the second signal transmission channel group to transmit the N image signals to the liquid crystal panel in order to show a second polarity pattern on the display panel.

In an optional embodiment, wherein, the first polarity pattern includes a first positive polarity pattern and a first negative polarity pattern, and the second polarity pattern includes a second positive polarity pattern and a second negative polarity pattern;

the method further includes:

detecting a polarity control signal;

when the polarity control signal is detected as a high voltage signal,

the step of using the first signal transmission channel group to transmit the N image signals to the display panel of the liquid crystal display in order to display the first polarity pattern on the display panel is to use the first signal transmission channel group to transmit the N image signals to the display panel of the liquid crystal display in order to display the first positive polarity pattern on the display panel; or

the step of using the second signal transmission channel group to transmit the N image signals to the display panel of the liquid crystal display in order to display the second polarity pattern on the display panel is to use the second signal transmission channel group to transmit the N image signals to the display panel of the liquid crystal display in order to display the second positive polarity pattern on the display panel;

when the polarity control signal is detected as a low voltage signal,

the step of using the first signal transmission channel group to transmit the N image signals to the display panel of the liquid crystal display in order to display the first polarity pattern on the display panel is to use the first signal transmission channel group to transmit the N image signals to the display panel of the liquid crystal display in order to display the first negative polarity pattern on the display panel; or

the step of using the second signal transmission channel group to transmit the N image signals to the display panel of the liquid crystal display in order to display the second polarity pattern on the display panel is to use the second signal transmission channel group to transmit the N image signals to the display panel of the liquid crystal display in order to display the second negative polarity pattern on the display panel.

In an optional embodiment, wherein, the driving device includes N output terminal, the step of building a first signal transmission channel group including N signal transmission channels includes:

connecting x input terminals of the driving device to input terminals of x positive polarity DAC circuits, connecting output terminals of x positive polarity DAC circuits to x output terminals of the driving device, wherein the x output terminals are adjacent x output terminals in the N output terminals;

connecting y input terminals of the driving device to input terminals of y negative polarity DAC circuits, and connecting output terminals of y negative polarity DAC circuits to the y output terminals of the driving device, wherein, the y output terminals are adjacent y output terminals in the N output terminals.

In an optional embodiment, wherein, the step of building a second signal transmission channel group including N signal transmission channels includes:

connecting x input terminals of the driving device to input terminals of x positive polarity DAC circuits, connecting output terminals of x positive polarity DAC circuits to x output terminals of the driving device, wherein the x output terminals are spaced x output terminals in the N output terminals;

connecting y input terminals of the driving device to input terminals of y negative polarity DAC circuits, and connecting output terminals of y negative polarity DAC circuits to the y output terminals of the driving device, wherein, the y output terminals are spaced y output terminals in the N output terminals.

In an optional embodiment, wherein, disposing a DAC array including N DAC circuits, wherein x positive polarity DAC circuits are adjacent, y negative polarity DAC circuits are adjacent, N is an integer multiple of a sum of x and y.

On another hand, the embodiment of the present disclosure provides a driving device for a liquid crystal display, comprising:

a mode detecting module for detecting a mode control signal;

a first building module for when the mode detection module detects that the mode control signal is at a high voltage signal, building a first signal transmission channel group including N signal transmission channels for N image signals inputting to N input terminals of a driving device of a liquid crystal display;

a first transmission module for using the first signal transmission channel group to transmit the N image signals to a display panel of the liquid crystal display in order to display a first polarity pattern on the display panel, the N is an integer greater than 1;

a second building module for when the mode detection module detects that the mode control signal is at a low voltage signal, building a second signal transmission channel group including N signal transmission channels for the N image signals inputting to the N input terminals of the driving device of the liquid crystal display;

a second transmission module for using the second signal transmission channel group to transmit the N image signals to the display panel of the liquid crystal display in order to display a second polarity pattern on the display panel.

In an optional embodiment, wherein, the first polarity pattern includes a first positive polarity pattern and a first negative polarity pattern, and the second polarity pattern includes a second positive polarity pattern and a second negative polarity pattern; the device further includes:

a polarity detection module for detecting a polarity control signal;

wherein, the first transmission module includes:

a first positive polarity transmission unit for when the polarity detection module detects that the polarity control signal is at a high voltage signal, using the first signal transmission channel group to transmit the N image signals to the display panel of the liquid crystal display in order to display the first polarity pattern on the display panel;

a first negative polarity transmission unit for when the polarity detection module detects that the polarity control signal is at a low voltage signal, using the first signal transmission channel group to transmit the N image signals to the display panel of the liquid crystal display in order to display the first negative polarity pattern on the display panel;

the second transmission module includes:

a second positive polarity transmission unit for when the polarity detection module detects that the polarity control signal is at a high voltage signal, using the second signal transmission channel group to transmit the N image signals to the display panel of the liquid crystal display in order to display a second positive polarity pattern on the display panel;

a second negative polarity transmission unit for when the polarity detection module detects that the polarity control signal is at a low voltage signal, using the second signal transmission channel group to transmit the N image signals to the display panel of the liquid crystal display in order to display a second negative polarity pattern on the display panel.

In an optional embodiment, wherein, the first building module includes:

a first adjacent connection unit for connecting x input terminals of the driving device to input terminals of x positive polarity DAC circuits, connecting output terminals of x positive polarity DAC circuits to x output terminals of the driving device, wherein, the driving device includes N output terminals, and the x output terminals are adjacent x output terminals in the N output terminals;

a second connection unit for connecting y input terminals of the driving device to input terminals of y negative polarity DAC circuits, and connecting output terminals of y negative polarity DAC circuits to the y output terminals of the driving device, wherein, the y output terminals are adjacent y output terminals in the N output terminals.

In an optional embodiment, wherein, the second building module includes:

a first spaced connection unit for connecting x input terminals of the driving device to input terminals of x positive polarity DAC circuits, connecting output terminals of the x positive polarity DAC circuits to x output terminals of the driving device, wherein the x output terminals are spaced x output terminals in the N output terminals;

a second spaced connection unit for connecting y input terminals of the driving device to input terminals of y negative polarity DAC circuits, and connecting output terminals of the y negative polarity DAC circuits to y output terminals of the driving device, wherein, the y output terminals are spaced y output terminals in the N output terminals.

In an optional embodiment, wherein, the device further includes:

a disposition module for disposing a DAC array including N DAC circuits, wherein, x positive polarity DAC circuits are adjacent, y negative polarity DAC circuits are adjacent, N is an integer multiple of a sum of x and y.

On another hand, the embodiment of the present disclosure provides a driving device of a liquid crystal display device including a storage device, a processor, N input terminals, N output terminals, wherein:

the N input terminals are used for inputting N image signals;

the N output terminals are used for connecting with a display panel of a liquid crystal display device to transmit the N image signals to the display panel;

the storage device stores with a group of program codes;

the processor allocates the program codes stored in the storage device to execute following operations:

detecting a mode control signal;

when the mode control signal is detected as a high voltage signal, building a first signal transmission channel group including N signal transmission channels for N image signals inputting to N input terminals of driving device of the liquid crystal display, using the first signal transmission channel group to transmit the N image signals to the liquid crystal panel in order to display a first polarity pattern on the display panel, the N is an integer greater than 1; and

when the mode control signal is detected as a low voltage signal, building a second signal transmission channel group including N signal transmission channels for N image signals inputting to N input terminals of driving device of the liquid crystal display, using the second signal transmission channel group to transmit N image signals to the liquid crystal panel in order to show a second polarity pattern on the display panel.

In an optional embodiment, wherein, the first polarity pattern includes a first positive polarity pattern and a first negative polarity pattern, and the second polarity pattern includes a second positive polarity pattern and a second negative polarity pattern; the processor allocates the program codes stored in the storage device, and further used to execute following operations:

detecting a polarity control signal;

when the polarity control signal is detected as a high voltage signal,

the processor uses the first signal transmission channel group to transmit the N image signals to the display panel of the liquid crystal display in order to display the first polarity pattern on the display panel, and is to:

use the first signal transmission channel group to transmit the N image signals to the display panel of the liquid crystal display in order to display the first positive polarity pattern on the display panel; or

the processor uses the second signal transmission channel group to transmit the N image signals to the display panel of the liquid crystal display in order to display the second polarity pattern on the display panel, and is to:

use the second signal transmission channel group to transmit the N image signals to the display panel of the liquid crystal display in order to display the second positive polarity pattern on the display panel;

when the polarity control signal is detected as a low voltage signal,

the processor uses the first signal transmission channel group to transmit the N image signals to the display panel of the liquid crystal display in order to display the first polarity pattern on the display panel, and is to:

use the first signal transmission channel group to transmit the N image signals to the display panel of the liquid crystal display in order to display the first negative polarity pattern on the display panel; or

the processor uses the second signal transmission channel group to transmit the N image signals to the display panel of the liquid crystal display in order to display the second polarity pattern on the display panel, and specifically is to:

use the second signal transmission channel group to transmit the N image signals to the display panel of the liquid crystal display in order to display the second negative polarity pattern on the display panel.

In an optional embodiment, wherein, the device further includes a first multiplexer, a second multiplexer and a DAC array, wherein, the first signal transmission channel group including N signal transmission channels for N image signals built by the processor includes:

using the first multiplexer to connect x input terminals of the driving device to input terminals of x positive polarity DAC circuits, using the second multiplexer to connect output terminals of x positive polarity DAC circuits to x output terminals of the driving device, wherein, the driving device includes N output terminals, and the x output terminals are adjacent x output terminals in the N output terminals;

using the first multiplexer to connect y input terminals of the driving device to input terminals of y negative polarity DAC circuits, and using the second multiplexer to connect output terminals of y negative polarity DAC circuits to the y output terminals of the driving device. Wherein, the y output terminals are adjacent y output terminals in the N output terminals.

In an optional embodiment, wherein, the second signal transmission channel group including N signal transmission channels for N image signals built by the processor includes:

using the first multiplexer to connect x input terminals of the driving device to input terminals of x positive polarity DAC circuits, connecting output terminals of x positive polarity DAC circuits to x output terminals in the N output terminals, wherein, the x output terminals are spaced x output terminals in the N output terminals; and

using the first multiplexer to connect y input terminals of the driving device to input terminals of y negative polarity DAC circuits, and connecting output terminals of y negative polarity DAC circuits to the y output terminals in the N output terminals. Wherein, the y output terminals are spaced y output terminals in the N output terminals.

In an optional embodiment, wherein, the device further includes: in the DAC array, x positive polarity DAC circuits are adjacent, y negative polarity DAC circuits are adjacent, N is an integer multiple of a sum of x and y.

In the embodiment of the present disclosure, through detecting the voltage level of the mode control signal as a high voltage or a low voltage level, different signal transmission channels for N image signals inputting to N input terminals of the driving device of the liquid crystal display device can be built; through different signal transmission channels to send N image signals to the display panel of the liquid crystal display, different polarity patterns can be displayed on the display panel in order to realize outputting multiple polarity patterns on the display panel to satisfy the requirement of multiple polarity output.

### BRIEF DESCRIPTION OF THE DRAWINGS

In order to more clearly illustrate the technical solution in the present disclosure or in the prior art, the following will illustrate the figures used for describing the embodiments or the prior art. It is obvious that the following figures are only some embodiments of the present disclosure. For the person of ordinary skill in the art without creative effort, it can also obtain other figures according to these figures.

FIG. 1 is a flowchart of a driving method for a liquid crystal display device according to an embodiment of the present invention;

FIG. 2 is a flowchart of a driving method for a liquid crystal display device according to another embodiment of the present disclosure;

FIG. 3 is a schematic structure diagram of a driving device of a liquid crystal display device according to an embodiment of the present disclosure;

FIG. 4 is a schematic structure diagram of a driving device of a liquid crystal display device according to another embodiment of the present disclosure; and

FIG. 5 is a schematic structure diagram of a driving device of a liquid crystal display device according to another embodiment of the present disclosure.

### DETAILED DESCRIPTION OF THE PREFERRED EMBODIMENT

The following content combines with the drawings and the embodiment for describing the present disclosure in detail. It is obvious that the following embodiments are only some embodiments of the present disclosure. For the person of ordinary skill in the art without creative effort, the other embodiments obtained thereby are still covered by the present disclosure.

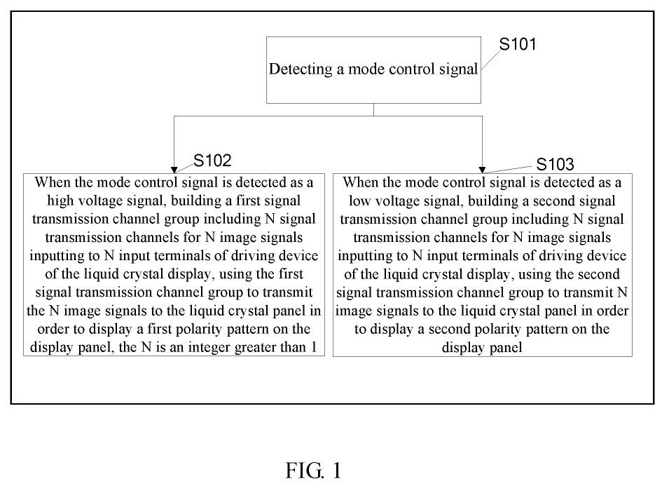

With reference to FIG. 1, and FIG. 1 is a flowchart of a driving method for a liquid crystal display device according to an embodiment of the present disclosure. The method includes following step:

Step S101, detecting a mode control signal.

In one embodiment, through detecting a mode control signal to determine a polarity output mode of a driving device. The mode control signal can be outputted from a controller. Wherein, the controller can send the mode control signal to control the polarity output mode of the driving device. According to different voltage levels of the mode control signal, different signal transmission groups for N image signals can be built in order to output different polarity patterns, and achieve the output of multi-polarity mode. The specific way can refer to step S102 and step S103.

Step S102, when the mode control signal is detected as a high voltage signal, building a first signal transmission channel group including N signal transmission channels for N image signals inputting to N input terminals of driving device of the liquid crystal display, using the first signal transmission channel group to transmit the N image signals to the liquid crystal panel in order to display a first polarity pattern on the display panel, the N is an integer greater than 1.

In one embodiment, when the mode control signal is detected as a high voltage signal, building the first signal transmission channel group including N signal transmission channels for N image signals inputting to N input terminals of the driving device, through the first signal transmission channel group, and the N image signals can be transmitted to the display panel of the liquid crystal device in order to display the first polarity pattern.

Specifically, the second signal transmission channel group can be built through multiple methods, one of the methods is: connecting x input terminals of the driving device to input terminals of x positive polarity DAC circuits, connecting output terminals of the x positive polarity DAC circuits to x output terminals of the driving device, wherein the x output terminals are spaced x output terminals in the N output terminals; connecting y input terminals of the driving device to input terminals of y negative polarity DAC circuits, and connecting output terminals of the y negative polarity DAC circuits to y output terminals of the driving device. Wherein, the y output terminals are spaced y output terminals in the N output terminals.

The first signal transmission channel group built by the above method can output x adjacent positive polarity signals and y adjacent negative polarity signals. That is, x output terminals of the N output channels having adjacent series numbers output positive polarity image data, y output terminals of the N output channels having adjacent series numbers output negative polarity image data. Wherein, N can be a sum of x and y, or N is an integer multiple of a sum of x and y. In case of the integer multiple, that is, x+y is an output unit, and outputted polarity signs is repeating according to the output unit. For example, when each of x and y is disposed as 4 such that 8 output terminals are one output unit. Accordingly, N output terminals can output repeating polarity signs using “++++−−−−” or “−−−−++++” as one output unit.

The first signal transmission group can be achieved by another method such as disposing DAC circuits having a same polarity in the driving device, and after passing through the DAC circuits, some terminals are provided with inverters. Under the above arrangement, the first signal transmission channel group is built such that N image data output a first polarity pattern at N output terminals after passing through the first signal transmission group. Other methods are not described in detail in the present embodiment.

Optionally, the first polarity pattern can includes a first positive polarity pattern and a first negative polarity pattern, and can be changed in adjacent frames in order to avoid the polarization phenomena of the liquid crystal display panel. Specifically, through above polarity control signal to control to output the first positive polarity pattern or the first negative polarity pattern. That is, at each frame, changing the voltage of the polarity control signal. For example, at a Nth frame, the polarity control signal is at a high voltage level, then, the first positive polarity pattern is outputted; at a (N+1)th frame, the polarity control signal is at a low voltage level, then, the first negative polarity pattern is outputted.

The above first positive polarity pattern and the first negative polarity pattern can be realized through the first signal transmission channel group. For example, when each of x and y is 4, and at the output terminals, serial numbers of the x output terminals are less than series numbers of the y output terminals. For example, serial numbers of the x output terminals are 1˜4, and serial numbers of the y output terminals are 5˜8, the output terminals output the first positive polarity pattern such as “++++−−−−” as one unit; when the serial numbers of the x output terminals are greater than the series numbers of the y output terminals, the output terminals output the first negative polarity pattern, such as a polarity pattern using “−−−−++++” as one unit.

Step S103, when the mode control signal is detected as a low voltage signal, building a second signal transmission channel group including N signal transmission channels for N image signals inputting to N input terminals of driving device of the liquid crystal display, using the second signal transmission channel group to transmit N image signals to the liquid crystal panel in order to display a second polarity pattern on the display panel.

In one embodiment, when the mode control signal is detected as a low voltage signal, building the second signal transmission channel group including N signal transmission channels for N image signals inputting to N input terminals of the driving device, through the first signal transmission channel group, N image signals can be transmitted to the display panel of the liquid crystal device in order to display the second polarity pattern.

Specifically, the second signal transmission channel group can be built through multiple methods, one of the methods is: connecting x input terminals of the driving device to x positive polarity DAC input terminals, connecting x positive polarity DAC output terminals to x output terminals of the driving device, wherein the x output terminals are spaced output terminals in N output terminals; connecting y input terminals of the driving device to y negative polarity DAC input terminals, and connecting y negative polarity DAC output terminals to the y output terminals of the driving device. Wherein, the y output terminals are spaced y output terminals of the driving device.

The second signal transmission channel group built by the above method can output x spaced positive polarity signals and y spaced negative polarity signals. A spaced unit can be 1 or an integer multiple of 1. For example, x output terminals of the N output channels having odd series numbers output positive polarity image data, and y output terminals of the N output channels having even series numbers output negative polarity image data. Wherein, N can be a sum of x and y, or N is an integer multiple of a sum of x and y. In case of the integer multiple, that is, x+y is an output unit, and outputted polarity signs are repeating according to the output unit. For example, when each of x and y is disposed as 1 such that 2 output terminals are one output unit. Accordingly, N output terminals can output repeating polarity signs using “+−” or “−+” as one output unit.

The second signal transmission group can be achieved by another method such as disposing DAC having a same polarity in the driving device, and after passing through the DAC, some terminals are provided with inverters. Under the above arrangement, the second signal transmission channel group is built such that N image data output a first polarity pattern at N output terminals after passing through the second signal transmission group. Other methods are not described in detail in the present embodiment.

Optionally, the second polarity pattern can includes a second positive polarity pattern and a second negative polarity pattern, and can be changed in adjacent frames in order to avoid the polarization phenomena of the liquid crystal display panel. Specifically, through above polarity control signal to control to output the second positive polarity pattern or the second negative polarity pattern. That is, at each frame, changing the voltage of the polarity control signal. For example, at a Nth frame, the polarity control signal is at a high voltage level, then, the second positive polarity pattern is outputted; at a (N+1)th frame, the polarity control signal is at a low voltage level, then, the second negative polarity pattern is outputted.

The above second positive polarity pattern and the second negative polarity pattern can be realized through the second signal transmission channel group. For example, when each of x and y is 1, and at the output terminals, serial numbers of the x output terminals are less than series numbers of the y output terminals. For example, serial numbers of the x output terminals are odd, and serial numbers of the y output terminals are even, the output terminals output the second positive polarity pattern such as “+−” as one unit; when the serial numbers of the x output terminals are greater than the series numbers of the y output terminals, the output terminals output the second negative polarity pattern, such as a polarity pattern using “−+” as one unit.

In the embodiment of the present disclosure, through detecting the voltage level of the mode control signal as a high voltage or a low voltage level, different signal transmission channels for N image signals inputting to N input terminals of the driving device of the liquid crystal display device can be built; through different signal transmission channels to send N image signals to the display panel of the liquid crystal display, different polarity patterns can be displayed on the display panel in order to realize outputting multiple polarity patterns on the display panel to satisfy the requirement of multi-polarity output.

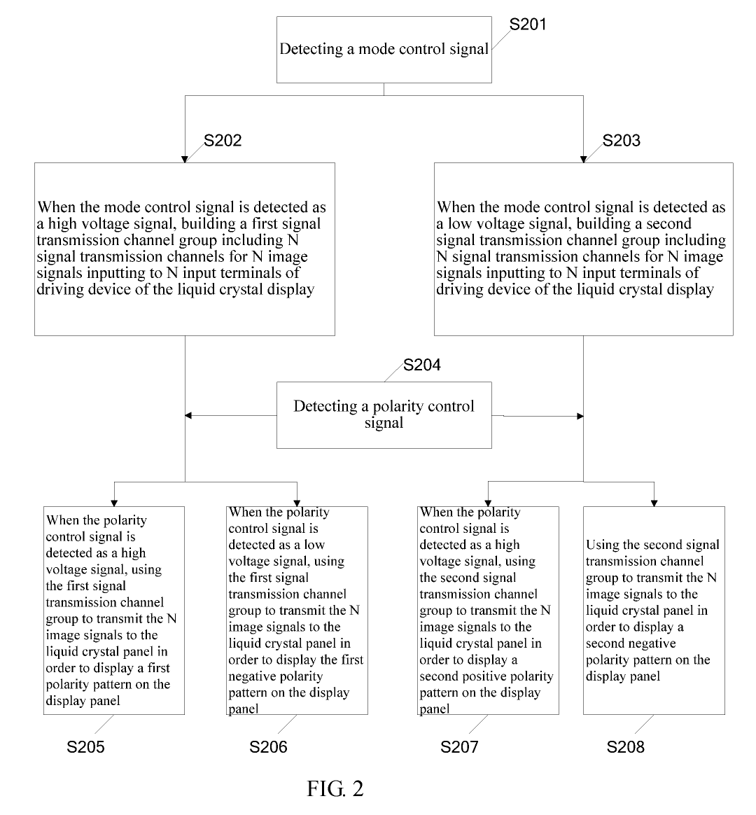

With reference to FIG. 2, and FIG. 2 is a flowchart of a driving method for a liquid crystal display device according to another embodiment of the present disclosure. The method includes following step:

Step S201, detecting a mode control signal.

In one embodiment, through detecting a mode control signal to determine a polarity output mode of a driving device. The mode control signal can be outputted from a controller. Wherein, the controller can send the mode control signal to control the polarity output mode of the driving device. According to different voltage levels of the mode control signal, different signal transmission groups for N image signals can be built in order to output different polarity patterns, and achieve the output of multi-polarity mode. The specific way can refer to step S202 and step S203.

Step S202, when the mode control signal is detected as a high voltage signal, building a first signal transmission channel group including N signal transmission channels for N image signals inputting to N input terminals of driving device of the liquid crystal display.

In one embodiment, according to the high voltage signal, the first signal transmission channel group including N signal transmission channels for N image signals inputting to N input terminals of the driving device is built.

Specifically, the first signal transmission channel group can be built through multiple methods, one of the methods is: connecting x input terminals of the driving device to input terminals of x positive polarity DAC circuits, connecting output terminals of x positive polarity DAC circuits to x output terminals of the driving device, wherein the x output terminals are adjacent x output terminals in the N output terminals; connecting y input terminals of the driving device to input terminals of y negative polarity DAC circuits, and connecting output terminals of y negative polarity DAC circuits to the y output terminals of the driving device. Wherein, the y output terminals are adjacent y output terminals in the N output terminals.

The first signal transmission channel group built by the above method can output x adjacent positive polarity signals and y adjacent negative polarity signals. That is, x output terminals of the N output channels having adjacent series numbers output positive polarity image data, y output terminals of the N output channels having adjacent series numbers output negative polarity image data. Wherein, N can be a sum of x and y, or N is an integer multiple of a sum of x and y. In case of the integer multiple, that is, x+y is an output unit, and outputted polarity signs is repeating according to the output unit. For example, when each of x and y is disposed as 4 such that 8 output terminals are one output unit. Accordingly, N output terminals can output repeating polarity signs using “++++−−−−” or “−−−−++++” as one output unit.

The first signal transmission group can be achieved by another method such as disposing DAC circuits having a same polarity in the driving device, and after passing through the DAC circuits, some terminals are provided with inverters. Under the above arrangement, the first signal transmission channel group is built such that the N image data output a first polarity pattern at the N output terminals after passing through the first signal transmission group. Other methods are not described in detail in the present embodiment.

In the present embodiment, a DAC array including N DAC circuits can be disposed in the driving device. Wherein, x positive polarity DAC circuits are adjacent, y negative polarity DAC circuits are adjacent, N is an integer multiple of a sum of x and y. Through disposing the DAC array, the number of the DAC circuits disposed by the driving circuit does not require changing, and building the first signal transmission group is more easily.

Step S203, when the mode control signal is detected as a low voltage signal, building a second signal transmission channel group including N signal transmission channels for N image signals inputting to N input terminals of driving device of the liquid crystal display.

In one embodiment, when the mode control signal is detected as a low voltage signal, according to the low voltage signal, the second signal transmission channel group including N signal transmission channels for N image signals inputting to the N input terminals of the driving device is built.

Specifically, the second signal transmission channel group can be built through multiple methods, one of the methods is: connecting x input terminals of the driving device to input terminals of x positive polarity DAC circuits, connecting output terminals of the x positive polarity DAC circuits to x output terminals of the driving device, wherein the x output terminals are spaced x output terminals in the N output terminals; connecting y input terminals of the driving device to input terminals of y negative polarity DAC circuits, and connecting output terminals of the y negative polarity DAC circuits to y output terminals of the driving device. Wherein, the y output terminals are spaced y output terminals in the N output terminals of the driving device.

The second signal transmission channel group built by the above method can output x spaced positive polarity signals and y spaced negative polarity signals. A spaced unit can be 1 or an integer multiple of 1. For example, the x output terminals of the N output channels having odd series numbers output positive polarity image data, and the y output terminals of the N output channels having even series numbers output negative polarity image data. Wherein, N can be a sum of x and y, or N is an integer multiple of a sum of x and y. In case of the integer multiple, that is, x+y is an output unit, and outputted polarity signs are repeating according to the output unit. For example, when each of x and y is disposed as 1 such that 2 output terminals are one output unit. Accordingly, the N output terminals can output repeating polarity signs using “+−” or “−+” as one output unit.

The second signal transmission group can be achieved by another method such as disposing DAC circuits having a same polarity in the driving device, and after passing through the DAC circuits, some terminals are provided with inverters. Under the above arrangement, the second signal transmission channel group is built such that the N image data output a second polarity pattern at the N output terminals after passing through the second signal transmission group. Other methods are not described in detail in the present embodiment.

In one embodiment, through the above controller to output the polarity control signal in order to control the polarities at the output terminals of the driving device to be inverted. That is, at a Nth frame, the output terminals output a positive polarity pattern; at a (N+1)th frame, performing an inversion to current output polarity of the image data, and at this time, the output terminals output a negative polarity pattern in order to avoid the polarization phenomena of the liquid crystal display panel. In one embodiment, the first polarity pattern can includes a first positive polarity pattern and a first negative polarity pattern; the second polarity pattern can include a second positive polarity pattern and a second negative polarity pattern. The driving device firstly detects the mode control signal, and selects to build the signal transmission channel group according to the mode control signal. Then the driving device detects the polarity control signal, and selects to output the positive polarity pattern or the negative polarity pattern in the signal transmission channel group built currently.

Step S205, when the polarity control signal is detected as a high voltage signal, using the first signal transmission channel group to transmit the N image signals to the liquid crystal panel in order to display a first polarity pattern on the display panel.

Step S206, when the polarity control signal is detected as a low voltage signal, using the first signal transmission channel group to transmit the N image signals to the liquid crystal panel in order to display the first negative polarity pattern on the display panel.

In one embodiment, when the mode control signal is at a high voltage level, building the first signal transmission channel group. After the first signal transmission channel group is built, detecting the polarity control signal. Because the polarity control signal usually changes the magnitude of the voltage level when transmitting image data of a new frame, the present embodiment can periodically detect the magnitude of the voltage level of the polarity control signal. If the detected polarity control signal is high, outputting the N image signals in order to display the first positive polarity pattern on the display panel, on the contrary, the first negative polarity pattern is displayed. It should be noted that in the present embodiment, a relationship between polarities of the first positive polarity pattern and polarities of the first negative polarity pattern is inverted. The first positive polarity pattern does not mean all of the polarities of the N image data are positive.

The above first positive polarity pattern and the first negative polarity pattern can be realized through the first signal transmission channel group. For example, when each of x and y is 4, and at the output terminals, serial numbers of the x output terminals are less than series numbers of the y output terminals. For example, serial numbers of the x output terminals are 1˜4, and serial numbers of the y output terminals are 5˜8, the output terminals output the first positive polarity pattern such as “++++−−−−” as one unit; when the serial numbers of the x output terminals are greater than the series numbers of the y output terminals, the output terminals output the first negative polarity pattern, such as a polarity pattern using “−−−−++++” as one unit.

Step S207, when the polarity control signal is detected as a high voltage signal, using the second signal transmission channel group to transmit the N image signals to the liquid crystal panel in order to display a second positive polarity pattern on the display panel.

Step S208, using the second signal transmission channel group to transmit the N image signals to the liquid crystal panel in order to display a second negative polarity pattern on the display panel.

In one embodiment, when the mode control signal is at a low voltage level, building the second signal transmission channel group. After the second signal transmission channel group is built, detecting the polarity control signal. Because the polarity control signal usually changes the magnitude of the voltage level when transmitting image data of a new frame, the present embodiment can periodically detect the magnitude of the voltage level of the polarity control signal. If the detected polarity control signal is high, outputting the N image signals in order to display the second positive polarity pattern on the display panel, on the contrary, the second negative polarity pattern is displayed. It should be noted that in the present embodiment, a relationship between polarities of the second positive polarity pattern and polarities of the second negative polarity pattern is inverted. The second positive polarity pattern does not mean all of the polarities of the N image data are positive.

The above second positive polarity pattern and the second negative polarity pattern can be realized through the second signal transmission channel group. For example, when each of x and y is 1, and at the output terminals, serial numbers of the x output terminals are less than series numbers of the y output terminals. For example, serial numbers of the x output terminals are odd, and serial numbers of the y output terminals are even, the output terminals output the second positive polarity pattern such as “+−” as one unit; when the serial numbers of the x output terminals are greater than the series numbers of the y output terminals, the output terminals output the second negative polarity pattern, such as a polarity pattern using “−+” as one unit.

In the embodiment of the present disclosure, through detecting the voltage level of the mode control signal as a high voltage or a low voltage level, different signal transmission channels for the N image signals inputting to the N input terminals of the driving device of the liquid crystal display device can be built; through different signal transmission channels to send the N image signals to the display panel of the liquid crystal display, different polarity patterns can be displayed on the display panel in order to realize outputting multiple polarity patterns on the display panel to satisfy the requirement of multiple polarity output.

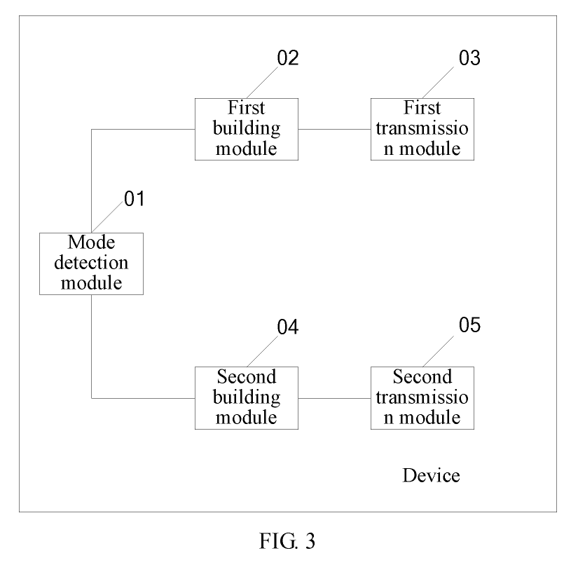

With reference to FIG. 3, FIG. 3 is a schematic structure diagram of a driving device of a liquid crystal display device according to an embodiment of the present disclosure. The device includes a mode detection module 01, a first building module 02, a first transmission module 03, a second building module 04 and a second transmission module 05.

Wherein, the mode detection module 01 is used for detecting a mode control signal.

In one embodiment, through the mode detection module 01 to detect a mode control signal to determine a polarity output mode of a driving device. The mode control signal can be outputted from a controller. Wherein, the controller can send the mode control signal to control the polarity output mode of the driving device. According to different voltage levels of the mode control signal, different signal transmission groups for N image signals can be built in order to output different polarity patterns, and achieve the output of multi-polarity mode. The specific way can refer to following modules.

The first building module 02 is used for when the mode detection module 01 detects that the mode control signal is at a high voltage signal, building a first signal transmission channel group including N signal transmission channels for N image signals inputting to N input terminals of driving device of the liquid crystal display.

The first transmission module 03 is used for using the first signal transmission channel group to transmit the N image signals to a display panel of the liquid crystal display in order to display a first polarity pattern on the display panel, the N is an integer greater than 1.

In one embodiment, when the mode detection module 01 detects that the mode control signal is at a high voltage signal, the first building module 02 builds the first signal transmission channel group including N signal transmission channels for N image signals inputting to N input terminals of the driving device. Through the first signal transmission channel group, the first transmission module 03 can transmit the N image signals to the display panel of the liquid crystal device in order to display the first polarity pattern.

Specifically, the first signal transmission channel group can be built through multiple methods, one of the methods is: connecting x input terminals of the driving device to input terminals of x positive polarity DAC circuits, connecting output terminals of x positive polarity DAC circuits to x output terminals of the driving device, wherein the x output terminals are adjacent x output terminals in the N output terminals; connecting y input terminals of the driving device to input terminals of y negative polarity DAC circuits, and connecting output terminals of y negative polarity DAC circuits to the y output terminals of the driving device. Wherein, the y output terminals are adjacent y output terminals in the N output terminals.

The first building module 02 can build the first signal transmission channel group by the above method, and the first transmission module 03 can output x adjacent positive polarity signals and y adjacent negative polarity signals. That is, x output terminals of the N output channels having adjacent series numbers output positive polarity image data, y output terminals of the N output channels having adjacent series numbers output negative polarity image data. Wherein, N can be a sum of x and y, or N is an integer multiple of a sum of x and y. In case of the integer multiple, that is, x+y is an output unit, and outputted polarity signs is repeating according to the output unit. For example, when each of x and y is disposed as 4 such that 8 output terminals are one output unit. Accordingly, N output terminals can output repeating polarity signs using “++++−−−−” or “−−−−++++” as one output unit.

The first signal transmission group can be achieved by another method such as disposing DAC circuits having a same polarity in the driving device, and after passing through the DAC circuits, some terminals are provided with inverters. Under the above arrangement, the first signal transmission channel group is built such that N image data output a first polarity pattern at N output terminals after passing through the first signal transmission group. Other methods are not described in detail in the present embodiment.

In the present embodiment, a DAC array including N DAC circuits can be disposed in the driving device. Wherein, x positive polarity DAC circuits are adjacent, y negative polarity DAC circuits are adjacent, N is an integer multiple of a sum of x and y. Through disposing the DAC array, the number of the DAC circuits disposed by the driving circuit does not require changing, and building the first signal transmission group is more easily.

The second building module 04 is used for when the mode detection module detects that the mode control signal is at a low voltage signal, building a second signal transmission channel group including N signal transmission channels for N image signals inputting to N input terminals of driving device of the liquid crystal display.

The second transmission module 05 is used for using the second signal transmission channel group to transmit the N image signals to the display panel of the liquid crystal display in order to display a second polarity pattern on the display panel.

In one embodiment, when the mode detection module 01 detects that the mode control signal is at a low voltage signal, the second building module 04 builds the second signal transmission channel group including N signal transmission channels for N image signals inputting to N input terminals of the driving device, through the second signal transmission channel group, the N image signals can be transmitted to the display panel of the liquid crystal device in order to display the second polarity pattern.

Specifically, the second signal transmission channel group can be built through multiple methods, one of the methods is: connecting x input terminals of the driving device to input terminals of x positive polarity DAC circuits, connecting output terminals of the x positive polarity DAC circuits to x output terminals of the driving device, wherein the x output terminals are spaced x output terminals in the N output terminals; connecting y input terminals of the driving device to input terminals of y negative polarity DAC circuits, and connecting output terminals of the y negative polarity DAC circuits to y output terminals of the driving device. Wherein, the y output terminals are spaced y output terminals in the N output terminals.

The second building module 04 builds the second signal transmission channel group by the above method, and the second transmission module 05 can output x spaced positive polarity signals and y spaced negative polarity signals. A spaced unit can be 1 or an integer multiple of 1. For example, the x output terminals of the N output channels having odd series numbers output positive polarity image data, and the y output terminals of the N output channels having even series numbers output negative polarity image data. Wherein, N can be a sum of x and y, or N is an integer multiple of a sum of x and y. In case of the integer multiple, that is, x+y is an output unit, and outputted polarity signs are repeating according to the output unit. For example, when each of x and y is disposed as 1 such that 2 output terminals are one output unit. Accordingly, the N output terminals can output repeating polarity signs using “+−” or “−+” as one output unit.

The second signal transmission group can be achieved by another method such as disposing DAC circuits having a same polarity in the driving device, and after passing through the DAC circuits, some terminals are provided with inverters. Under the above arrangement, the second signal transmission channel group is built such that the N image data output a second polarity pattern at the N output terminals after passing through the second signal transmission group. Other methods are not described in detail in the present embodiment.

Optionally, the second polarity pattern can includes a second positive polarity pattern and a second negative polarity pattern, and can be changed in adjacent frames in order to avoid the polarization phenomena of the liquid crystal display panel. Specifically, through above polarity control signal to control to output the second positive polarity pattern or the second negative polarity pattern. That is, at each frame, changing the voltage of the polarity control signal. For example, at a Nth frame, the polarity control signal is at a high voltage level, then, the second positive polarity pattern is outputted; at a (N+1)th frame, the polarity control signal is at a low voltage level, then, the second negative polarity pattern is outputted.

The above second positive polarity pattern and the second negative polarity pattern can be realized through the second signal transmission channel group. For example, when each of x and y is 1, and at the output terminals, serial numbers of the x output terminals are less than series numbers of the y output terminals. For example, serial numbers of the x output terminals are odd, and serial numbers of the y output terminals are even, the output terminals output the second positive polarity pattern such as “+−” as one unit; when the serial numbers of the x output terminals are greater than the series numbers of the y output terminals, the output terminals output the second negative polarity pattern, such as a polarity pattern using “−+” as one unit.

In the embodiment of the present disclosure, through detecting the voltage level of the mode control signal as a high voltage or a low voltage level, different signal transmission channels for the N image signals inputting to the N input terminals of the driving device of the liquid crystal display device can be built; through different signal transmission channels to send the N image signals to the display panel of the liquid crystal display, different polarity patterns can be displayed on the display panel in order to realize outputting multiple polarity patterns on the display panel to satisfy the requirement of multiple polarity output.

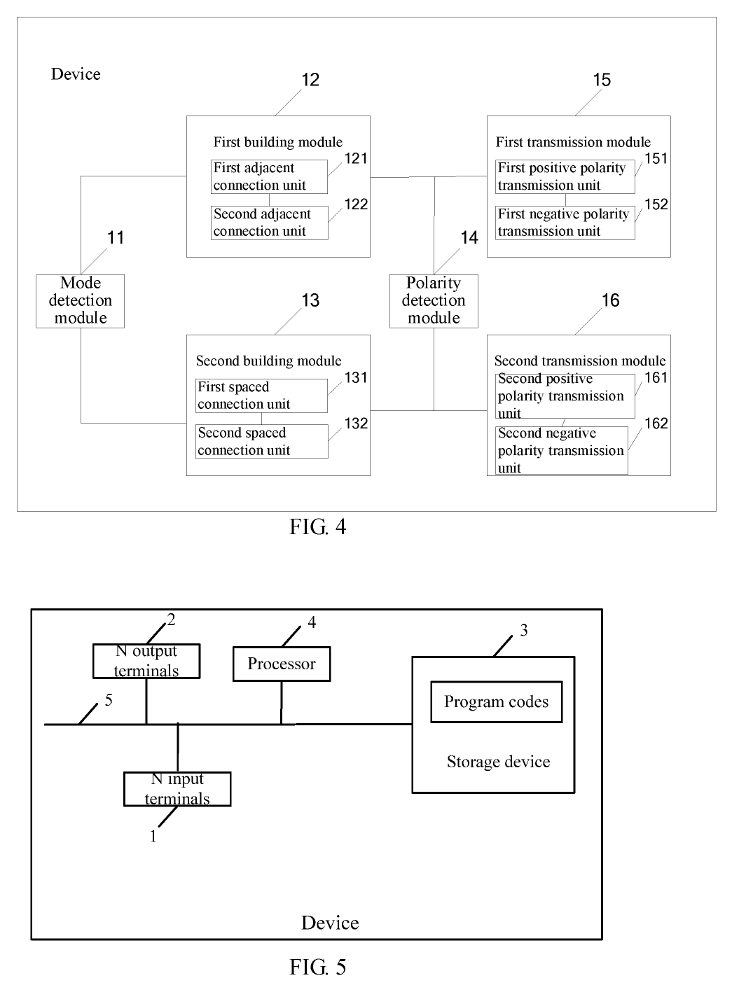

With reference to FIG. 4, and FIG. 4 is a schematic structure diagram of a driving device of a liquid crystal display device according to an embodiment of the present disclosure. The device includes a mode detection module 11, a first building module 12, a second building module 13, a polarity detection module 14, a first transmission module 15, and a second transmission module 16.

Wherein, the mode detection module 11 is used for detecting a mode control signal.

In one embodiment, the model detection module 11 can detect a mode control signal to determine a polarity output mode of a driving device. The mode control signal can be outputted from a controller. Wherein, the controller can send the mode control signal to control the polarity output mode of the driving device. According to different voltage levels of the mode control signal, different signal transmission groups for N image signals can be built in order to output different polarity patterns, and achieve the output of multi-polarity mode. The specific way can refer to following steps.

The first building module 12 is used for when the mode detection module 11 detects that the mode control signal is at a high voltage signal, building a first signal transmission channel group including N signal transmission channels for N image signals inputting to N input terminals of driving device of the liquid crystal display.

In the present embodiment, the first building module 12 includes a first adjacent connection unit 121, a second adjacent connection unit 122.

Wherein, the first adjacent connection unit 121 is used for connecting x input terminals of the driving device to input terminals of x positive polarity DAC circuits, connecting output terminals of x positive polarity DAC circuits to x output terminals of the driving device, wherein, the driving device includes N output terminals, and the x output terminals are adjacent x output terminals in the N output terminals.

The second connection unit 122 is used for connecting y input terminals of the driving device to input terminals of y negative polarity DAC circuits, and connecting output terminals of y negative polarity DAC circuits to the y output terminals of the driving device. Wherein, the y output terminals are adjacent y output terminals in the N output terminals.

The first signal transmission channel group built by the above method can output x adjacent positive polarity signals and y adjacent negative polarity signals. That is, x output terminals of the N output channels having adjacent series numbers output positive polarity image data, y output terminals of the N output channels having adjacent series numbers output negative polarity image data. Wherein, N can be a sum of x and y, or N is an integer multiple of a sum of x and y. In case of the integer multiple, that is, x+y is an output unit, and outputted polarity signs is repeating according to the output unit. For example, when each of x and y is disposed as 4 such that 8 output terminals are one output unit. Accordingly, N output terminals can output repeating polarity signs using “++++−−−−” or “−−−−++++” as one output unit.

The first signal transmission group can be achieved by another method such as disposing DAC circuits having a same polarity in the driving device, and after passing through the DAC circuits, some terminals are provided with inverters. Under the above arrangement, the first signal transmission channel group is built such that the N image data output a first polarity pattern at the N output terminals after passing through the first signal transmission group. Other methods are not described in detail in the present embodiment.

In the present embodiment, a DAC array including N DAC circuits can be disposed in the driving device. Wherein, x positive polarity DAC circuits are adjacent, y negative polarity DAC circuits are adjacent, N is an integer multiple of a sum of x and y. Through disposing the DAC array, the number of the DAC circuits disposed by the driving circuit does not require changing, and building the first signal transmission group is more easily.

The second building module 13 is used for when the mode detection module detects that the mode control signal is at a low voltage signal, building a second signal transmission channel group including N signal transmission channels for N image signals inputting to N input terminals of driving device of the liquid crystal display.

In the present embodiment, the second building module 13 includes a first spaced connection unit 131 and a second spaced connection unit 132.

Wherein, the first spaced connection unit 131 is used for connecting x input terminals of the driving device to input terminals of x positive polarity DAC circuits, connecting output terminals of the x positive polarity DAC circuits to x output terminals of the driving device, wherein the x output terminals are spaced x output terminals in the N output terminals.

The second spaced connection unit 132 is used for connecting y input terminals of the driving device to input terminals of y negative polarity DAC circuits, and connecting output terminals of the y negative polarity DAC circuits to y output terminals of the driving device. Wherein, the y output terminals are spaced y output terminals in the N output terminals.

The second signal transmission channel group built by the above method can output x spaced positive polarity signals and y spaced negative polarity signals. A spaced unit can be 1 or an integer multiple of 1. For example, the x output terminals of the N output channels having odd series numbers output positive polarity image data, and the y output terminals of the N output channels having even series numbers output negative polarity image data. Wherein, N can be a sum of x and y, or N is an integer multiple of a sum of x and y. In case of the integer multiple, that is, x+y is an output unit, and outputted polarity signs are repeating according to the output unit. For example, when each of x and y is disposed as 1 such that 2 output terminals are one output unit. Accordingly, the N output terminals can output repeating polarity signs using “+−” or “−+” as one output unit.

The second signal transmission group can be achieved by another method such as disposing DAC circuits having a same polarity in the driving device, and after passing through the DAC circuits, some terminals are provided with inverters. Under the above arrangement, the second signal transmission channel group is built such that the N image data output a second polarity pattern at the N output terminals after passing through the second signal transmission group. Other methods are not described in detail in the present embodiment.

The polarity detection module 14 is used for detecting a polarity control signal.

In one embodiment, through the above controller to output the polarity control signal, and the polarity detection module 14 detects the polarity control signal in order to control the polarities at the output terminals of the driving device to be inverted. That is, at a Nth frame, the output terminals output a positive polarity pattern; at a (N+1)th frame, performing an inversion to current output polarity of the image data, and at this time, the output terminals output a negative polarity pattern in order to avoid the polarization phenomena of the liquid crystal display panel. In one embodiment, the first polarity pattern can includes a first positive polarity pattern and a first negative polarity pattern; the second polarity pattern can include a second positive polarity pattern and a second negative polarity pattern. The driving device firstly detects the mode control signal, and selects to build the signal transmission channel group according to the mode control signal. Then the driving device detects the polarity control signal, and selects to output the positive polarity pattern or the negative polarity pattern in the signal transmission channel group built currently.

The first transmission module 15 is used for using the first signal transmission channel group to transmit the N image signals to the liquid crystal panel in order to display a first polarity pattern on the display panel, wherein N is an integer that is greater than 1.

In the present embodiment, the first transmission module 15 includes a first positive polarity transmission unit 151 and a first negative polarity transmission unit 152.

Wherein, the first positive polarity transmission unit 151 is used for when the polarity detection module 14 detects that the polarity control signal is at a high voltage signal, using the first signal transmission channel group to transmit the N image signals to the display panel of the liquid crystal display in order to display the first polarity pattern on the display panel.

The first negative polarity transmission unit 152 is used for when the polarity detection module 14 detects that the polarity control signal is at a low voltage signal, using the first signal transmission channel group to transmit the N image signals to the display panel of the liquid crystal display in order to display the first negative polarity pattern on the display panel.

In one embodiment, when the mode control signal is at a high voltage level, building the first signal transmission channel group. After the first signal transmission channel group is built, detecting the polarity control signal. Because the polarity control signal usually changes the magnitude of the voltage level when transmitting image data of a new frame, the present embodiment can periodically detect the magnitude of the voltage level of the polarity control signal. If the detected polarity control signal is high, the first positive polarity transmission unit 151 outputs the N image signals in order to display the first positive polarity pattern on the display panel, on the contrary, the first negative polarity transmission unit 152 displays the first negative polarity pattern. It should be noted that in the present embodiment, a relationship between polarities of the first positive polarity pattern and polarities of the first negative polarity pattern is inverted. The first positive polarity pattern does not mean all of the polarities of the N image data are positive.

The above first positive polarity pattern and the first negative polarity pattern can be realized through the first signal transmission channel group. For example, when each of x and y is 4, and at the output terminals, serial numbers of the x output terminals are less than series numbers of the y output terminals. For example, serial numbers of the x output terminals are 1˜4, and serial numbers of the y output terminals are 5˜8, the first positive polarity transmission unit 151 outputs the first positive polarity pattern such as “++++−−−−” as one unit; when the serial numbers of the x output terminals are greater than the series numbers of the y output terminals, the first negative polarity transmission unit 152 outputs the first negative polarity pattern, such as a polarity pattern using “−−−−++++” as one unit.

The second transmission module 16 is used for using the second signal transmission channel group to transmit the N image signals to the liquid crystal panel in order to display a second polarity pattern on the display panel.

In the present embodiment, the second transmission module 16 includes a second positive polarity transmission unit 161 and a second negative polarity transmission unit 161.

Wherein, the second positive polarity transmission unit 161 is used for when the polarity detection module 14 detects that the polarity control signal is at a high voltage signal, using the second signal transmission channel group to transmit the N image signals to the display panel of the liquid crystal display in order to display a second positive polarity pattern on the display panel.

The second negative polarity transmission unit 162 is used for when the polarity detection module 14 detects that the polarity control signal is at a low voltage signal, using the second signal transmission channel group to transmit the N image signals to the display panel of the liquid crystal display in order to display a second negative polarity pattern on the display panel.

In one embodiment, when the mode control signal is at a low voltage level, building the second signal transmission channel group. After the second signal transmission channel group is built, detecting the polarity control signal. Because the polarity control signal usually changes the magnitude of the voltage level when transmitting image data of a new frame, the present embodiment can periodically detect the magnitude of the voltage level of the polarity control signal. If the detected polarity control signal is high, outputting the N image signals in order to display the second positive polarity pattern on the display panel, on the contrary, the second negative polarity pattern is displayed. It should be noted that in the present embodiment, a relationship between polarities of the second positive polarity pattern and polarities of the second negative polarity pattern is inverted. The second positive polarity pattern does not mean all of the polarities of the N image data are positive.

The above second positive polarity pattern and the second negative polarity pattern can be realized through the second signal transmission channel group. For example, when each of x and y is 1, and at the output terminals, serial numbers of the x output terminals are less than series numbers of the y output terminals. For example, serial numbers of the x output terminals are odd, and serial numbers of the y output terminals are even, the second positive polarity transmission unit 161 outputs the second positive polarity pattern such as “+−” as one unit; when the serial numbers of the x output terminals are greater than the series numbers of the y output terminals, the second negative polarity transmission unit 162 outputs the second negative polarity pattern, such as a polarity pattern using “−+” as one unit.

In the embodiment of the present disclosure, through detecting the voltage level of the mode control signal as a high voltage or a low voltage level, different signal transmission channels for the N image signals inputting to the N input terminals of the driving device of the liquid crystal display device can be built; through different signal transmission channels to send the N image signals to the display panel of the liquid crystal display, different polarity patterns can be displayed on the display panel in order to realize outputting multiple polarity patterns on the display panel to satisfy the requirement of multiple polarity output.

With reference to FIG. 5, and FIG. 5 is a schematic structure diagram of a driving device of a liquid crystal display device according to another embodiment of the present disclosure. The driving device can includes N input terminals 1, N output terminals 2, a storage device 3, at least one processor 4 such as a CPU, and a communication bus 5. Wherein, the communication bus 5 is used for realizing a connection and communication among the above parts. The storage device 3 is a high speed RAM storage device or a non-volatile memory such as a disk storage device. Optionally, the storage device 3 can be a storage device located away from the processor 4. The N output terminals 1 is used for connecting with a display panel of a liquid crystal display device to transmit the N image signals to the display panel. The storage device 3 is stored with a group of program codes. The processor 4 allocates the program codes stored in the storage device 3 to execute following operations:

detecting a mode control signal;

when the mode control signal is detected as a high voltage signal, building a first signal transmission channel group including N signal transmission channels for N image signals inputting to N input terminals of driving device of the liquid crystal display, using the first signal transmission channel group to transmit the N image signals to the liquid crystal panel in order to display a first polarity pattern on the display panel, the N is an integer greater than 1;

when the mode control signal is detected as a low voltage signal, building a second signal transmission channel group including N signal transmission channels for N image signals inputting to N input terminals of driving device of the liquid crystal display, using the second signal transmission channel group to transmit N image signals to the liquid crystal panel in order to display a second polarity pattern on the display panel.

For an optional embodiment, the first polarity pattern includes a first positive polarity pattern and a first negative polarity pattern, and the second polarity pattern includes a second positive polarity pattern and a second negative polarity pattern;

The processor allocates the program codes stored in the storage device, and executing following operations:

detecting a polarity control signal;

when the polarity control signal is detected as a high voltage signal,

the processor 4 uses the first signal transmission channel group to transmit the N image signals to the display panel of the liquid crystal display in order to display the first polarity pattern on the display panel, and specifically is:

using the first signal transmission channel group to transmit the N image signals to the display panel of the liquid crystal display in order to display the first positive polarity pattern on the display panel; or

the processor 4 uses the second signal transmission channel group to transmit the N image signals to the display panel of the liquid crystal display in order to display the second polarity pattern on the display panel, and specifically is:

using the second signal transmission channel group to transmit the N image signals to the display panel of the liquid crystal display in order to display the second positive polarity pattern on the display panel;

when the polarity control signal is detected as a low voltage signal,

the processor 4 uses the first signal transmission channel group to transmit the N image signals to the display panel of the liquid crystal display in order to display the first polarity pattern on the display panel, and specifically is:

using the first signal transmission channel group to transmit the N image signals to the display panel of the liquid crystal display in order to display the first negative polarity pattern on the display panel; or

the processor 4 uses the second signal transmission channel group to transmit the N image signals to the display panel of the liquid crystal display in order to display the second polarity pattern on the display panel, and specifically is:

using the second signal transmission channel group to transmit the N image signals to the display panel of the liquid crystal display in order to display the second negative polarity pattern on the display panel.

In an optional embodiment, the driving device further includes a first multiplexer, a second multiplexer and a DAC array. Wherein, the first signal transmission channel group including N signal transmission channels for N image signals built by the processor 4 includes:

using the first multiplexer to connect x input terminals of the driving device to input terminals of x positive polarity DAC circuits, using the second multiplexer to connect output terminals of x positive polarity DAC circuits to x output terminals of the driving device, wherein, the driving device includes N output terminals, and the x output terminals are adjacent x output terminals in the N output terminals;

using the first multiplexer to connect y input terminals of the driving device to input terminals of y negative polarity DAC circuits, and using the second multiplexer to connect output terminals of y negative polarity DAC circuits to the y output terminals of the driving device. Wherein, the y output terminals are adjacent y output terminals in the N output terminals.

In an optional embodiment, the second signal transmission channel group including N signal transmission channels for N image signals built by the processor 4 includes:

using the first multiplexer to connect x input terminals of the driving device to input terminals of x positive polarity DAC circuits, connecting output terminals of x positive polarity DAC circuits to x output terminals in the N output terminals, wherein, the x output terminals are spaced x output terminals in the N output terminals;

using the first multiplexer to connect y input terminals of the driving device to input terminals of y negative polarity DAC circuits, and connecting output terminals of y negative polarity DAC circuits to the y output terminals in the N output terminals. Wherein, the y output terminals are spaced y output terminals in the N output terminals.

In an optional embodiment, in the DAC array, x positive polarity DAC circuits are adjacent, y negative polarity DAC circuits are adjacent, N is an integer multiple of a sum of x and y. T

In the embodiment of the present disclosure, through detecting the voltage level of the mode control signal as a high voltage or a low voltage level, different signal transmission channels for the N image signals inputting to the N input terminals of the driving device of the liquid crystal display device can be built; through different signal transmission channels to send the N image signals to the display panel of the liquid crystal display, different polarity patterns can be displayed on the display panel in order to realize outputting multiple polarity patterns on the display panel to satisfy the requirement of multiple polarity output.

The embodiments for describing the above devices are schematic, the unit illustrating as the separate components may be or may not be separated in Physics. The components for unit display may be or may not be a physical unit, that is, located at one place or distributed at multiple network units. According to an actual requirement, selecting portion of all modules to realize the purpose of the present embodiment. For the person of ordinary skill in the art without creative effort, it can understand and implement.

The steps of the embodiments of the present disclosure can adjust the sequence, combine or delete according to an actual requirement.

The unit or sub-unit in the terminal or device of the embodiments of the present disclosure can be combined, divided or deleted according to an actually requirement.

Through the description of the above embodiments, person skilled in the art can clearly understand the embodiments can adopt the software and necessary general hardware platform to realize. Of course, it can also adopt the hardware. Base on the understanding, the nature of the above technology solution or the contribution part comparing with the prior art can be reflected in a software product form, and the software product can be stored in a computer or readable media such as ROM/RAM, disk or CD-ROM including some instructions such that a computer device (can be a person computer, a server or a network device) executes the method in each embodiment or part pf the method in each embodiment.

The above embodiments of the present disclosure are not used to limit the claims of this disclosure. Any use of the content in the specification or in the drawings of the present disclosure which produces equivalent structures or equivalent processes, or directly or indirectly used in other related technical fields is still covered by the claims in the present disclosure.

1. A driving method for a liquid crystal display device, comprising:
detecting a mode control signal;
when the mode control signal is detected as a high voltage signal, building a first signal transmission channel group including N signal transmission channels for N image signals inputting to N input terminals of a driving device of a liquid crystal display, using the first signal transmission channel group to transmit the N image signals to the liquid crystal panel in order to display a first polarity pattern on the display panel, and N is an integer greater than 1;
when the mode control signal is detected as a low voltage signal, building a second signal transmission channel group including N signal transmission channels for the N image signals inputting to the N input terminals of the driving device of the liquid crystal display, using the second signal transmission channel group to transmit the N image signals to the liquid crystal panel in order to display a second polarity pattern on the display panel.

2. The method according to claim 1, wherein,
the first polarity pattern includes a first positive polarity pattern and a first negative polarity pattern, and the second polarity pattern includes a second positive polarity pattern and a second negative polarity pattern;
the method further includes:
detecting a polarity control signal;
when the polarity control signal is detected as a high voltage signal,
the step of using the first signal transmission channel group to transmit the N image signals to the display panel of the liquid crystal display in order to display the first polarity pattern on the display panel is to use the first signal transmission channel group to transmit the N image signals to the display panel of the liquid crystal display in order to display the first positive polarity pattern on the display panel; or
the step of using the second signal transmission channel group to transmit the N image signals to the display panel of the liquid crystal display in order to display the second polarity pattern on the display panel is to use the second signal transmission channel group to transmit the N image signals to the display panel of the liquid crystal display in order to display the second positive polarity pattern on the display panel;
when the polarity control signal is detected as a low voltage signal,
the step of using the first signal transmission channel group to transmit the N image signals to the display panel of the liquid crystal display in order to display the first polarity pattern on the display panel is to use the first signal transmission channel group to transmit the N image signals to the display panel of the liquid crystal display in order to display the first negative polarity pattern on the display panel; or
the step of using the second signal transmission channel group to transmit the N image signals to the display panel of the liquid crystal display in order to display the second polarity pattern on the display panel is to use the second signal transmission channel group to transmit the N image signals to the display panel of the liquid crystal display in order to display the second negative polarity pattern on the display panel.

3. The method according to claim 1 or 2, wherein,
the driving device includes N output terminal, the step of building a first signal transmission channel group including N signal transmission channels includes:
connecting x input terminals of the driving device to input terminals of x positive polarity DAC circuits, connecting output terminals of x positive polarity DAC circuits to x output terminals of the driving device, wherein the x output terminals are adjacent x output terminals in the N output terminals;
connecting y input terminals of the driving device to input terminals of y negative polarity DAC circuits, and connecting output terminals of y negative polarity DAC circuits to the y output terminals of the driving device, wherein, the y output terminals are adjacent y output terminals in the N output terminals.

4. The method according to claim 3, wherein,
the step of building a second signal transmission channel group including N signal transmission channels includes:
connecting x input terminals of the driving device to input terminals of x positive polarity DAC circuits, connecting output terminals of x positive polarity DAC circuits to x output terminals of the driving device, wherein the x output terminals are spaced x output terminals in the N output terminals;
connecting y input terminals of the driving device to input terminals of y negative polarity DAC circuits, and connecting output terminals of y negative polarity DAC circuits to the y output terminals of the driving device, wherein, the y output terminals are spaced y output terminals in the N output terminals.

5. The method according to claim 4, wherein, the method further includes:
disposing a DAC array including N DAC circuits, wherein x positive polarity DAC circuits are adjacent, y negative polarity DAC circuits are adjacent, N is an integer multiple of a sum of x and y.

6. A driving device for a liquid crystal display, comprising:
a mode detecting module for detecting a mode control signal;
a first building module for when the mode detection module detects that the mode control signal is at a high voltage signal, building a first signal transmission channel group including N signal transmission channels for N image signals inputting to N input terminals of a driving device of a liquid crystal display;
a first transmission module for using the first signal transmission channel group to transmit the N image signals to a display panel of the liquid crystal display in order to display a first polarity pattern on the display panel, the N is an integer greater than 1;
a second building module for when the mode detection module detects that the mode control signal is at a low voltage signal, building a second signal transmission channel group including N signal transmission channels for the N image signals inputting to the N input terminals of the driving device of the liquid crystal display;
a second transmission module for using the second signal transmission channel group to transmit the N image signals to the display panel of the liquid crystal display in order to display a second polarity pattern on the display panel.

7. The device according to claim 6, wherein,
the first polarity pattern includes a first positive polarity pattern and a first negative polarity pattern, and the second polarity pattern includes a second positive polarity pattern and a second negative polarity pattern; the device further includes:
a polarity detection module for detecting a polarity control signal;
wherein, the first transmission module includes:
a first positive polarity transmission unit for when the polarity detection module detects that the polarity control signal is at a high voltage signal, using the first signal transmission channel group to transmit the N image signals to the display panel of the liquid crystal display in order to display the first polarity pattern on the display panel;
a first negative polarity transmission unit for when the polarity detection module detects that the polarity control signal is at a low voltage signal, using the first signal transmission channel group to transmit the N image signals to the display panel of the liquid crystal display in order to display the first negative polarity pattern on the display panel;
the second transmission module includes:
a second positive polarity transmission unit for when the polarity detection module detects that the polarity control signal is at a high voltage signal, using the second signal transmission channel group to transmit the N image signals to the display panel of the liquid crystal display in order to display a second positive polarity pattern on the display panel;
a second negative polarity transmission unit for when the polarity detection module detects that the polarity control signal is at a low voltage signal, using the second signal transmission channel group to transmit the N image signals to the display panel of the liquid crystal display in order to display a second negative polarity pattern on the display panel.

8. The device according to claim 6 or 7, wherein, the first building module includes:
a first adjacent connection unit for connecting x input terminals of the driving device to input terminals of x positive polarity DAC circuits, connecting output terminals of x positive polarity DAC circuits to x output terminals of the driving device, wherein, the driving device includes N output terminals, and the x output terminals are adjacent x output terminals in the N output terminals;
a second connection unit for connecting y input terminals of the driving device to input terminals of y negative polarity DAC circuits, and connecting output terminals of y negative polarity DAC circuits to the y output terminals of the driving device, wherein, the y output terminals are adjacent y output terminals in the N output terminals.

9. The device according to claim 8 wherein, the second building module includes:
a first spaced connection unit for connecting x input terminals of the driving device to input terminals of x positive polarity DAC circuits, connecting output terminals of the x positive polarity DAC circuits to x output terminals of the driving device, wherein the x output terminals are spaced x output terminals in the N output terminals;
a second spaced connection unit for connecting y input terminals of the driving device to input terminals of y negative polarity DAC circuits, and connecting output terminals of the y negative polarity DAC circuits to y output terminals of the driving device, wherein, the y output terminals are spaced y output terminals in the N output terminals.

10. The device according to claim 9, wherein, the device further includes:
a disposition module for disposing a DAC array including N DAC circuits, wherein, x positive polarity DAC circuits are adjacent, y negative polarity DAC circuits are adjacent, N is an integer multiple of a sum of x and y.

11. A driving device of a liquid crystal display device including a storage device, a processor, N input terminals, N output terminals, wherein:
the N input terminals is used for inputting N image signals;
the N output terminals are used for connecting with a display panel of a liquid crystal display device to transmit the N image signals to the display panel;
the storage device stores with a group of program codes;
the processor allocates the program codes stored in the storage device to execute following operations:
detecting a mode control signal;
when the mode control signal is detected as a high voltage signal, building a first signal transmission channel group including N signal transmission channels for N image signals inputting to N input terminals of driving device of the liquid crystal display, using the first signal transmission channel group to transmit the N image signals to the liquid crystal panel in order to display a first polarity pattern on the display panel, the N is an integer greater than 1; and
when the mode control signal is detected as a low voltage signal, building a second signal transmission channel group including N signal transmission channels for N image signals inputting to N input terminals of driving device of the liquid crystal display, using the second signal transmission channel group to transmit N image signals to the liquid crystal panel in order to display a second polarity pattern on the display panel.

12. The device according to claim 11, wherein, the first polarity pattern includes a first positive polarity pattern and a first negative polarity pattern, and the second polarity pattern includes a second positive polarity pattern and a second negative polarity pattern;
the processor allocates the program codes stored in the storage device, and further used to execute following operations:
detecting a polarity control signal;
when the polarity control signal is detected as a high voltage signal,
the processor uses the first signal transmission channel group to transmit the N image signals to the display panel of the liquid crystal display in order to display the first polarity pattern on the display panel, and is to:
use the first signal transmission channel group to transmit the N image signals to the display panel of the liquid crystal display in order to display the first positive polarity pattern on the display panel; or
the processor uses the second signal transmission channel group to transmit the N image signals to the display panel of the liquid crystal display in order to display the second polarity pattern on the display panel, and is to:
use the second signal transmission channel group to transmit the N image signals to the display panel of the liquid crystal display in order to display the second positive polarity pattern on the display panel;
when the polarity control signal is detected as a low voltage signal,
the processor uses the first signal transmission channel group to transmit the N image signals to the display panel of the liquid crystal display in order to display the first polarity pattern on the display panel, and is to:
use the first signal transmission channel group to transmit the N image signals to the display panel of the liquid crystal display in order to display the first negative polarity pattern on the display panel; or
the processor uses the second signal transmission channel group to transmit the N image signals to the display panel of the liquid crystal display in order to display the second polarity pattern on the display panel, and specifically is to:
use the second signal transmission channel group to transmit the N image signals to the display panel of the liquid crystal display in order to display the second negative polarity pattern on the display panel.

13. The device according to claim 11 or 12, wherein, the device further includes a first multiplexer, a second multiplexer and a DAC array, wherein, the first signal transmission channel group including N signal transmission channels for N image signals built by the processor includes:
using the first multiplexer to connect x input terminals of the driving device to input terminals of x positive polarity DAC circuits, using the second multiplexer to connect output terminals of x positive polarity DAC circuits to x output terminals of the driving device, wherein, the driving device includes N output terminals, and the x output terminals are adjacent x output terminals in the N output terminals;
using the first multiplexer to connect y input terminals of the driving device to input terminals of y negative polarity DAC circuits, and using the second multiplexer to connect output terminals of y negative polarity DAC circuits to the y output terminals of the driving device. Wherein, the y output terminals are adjacent y output terminals in the N output terminals.

14. The device according to claim 13, wherein, the second signal transmission channel group including N signal transmission channels for N image signals built by the processor includes:
using the first multiplexer to connect x input terminals of the driving device to input terminals of x positive polarity DAC circuits, connecting output terminals of x positive polarity DAC circuits to x output terminals in the N output terminals, wherein, the x output terminals are spaced x output terminals in the N output terminals; and
using the first multiplexer to connect y input terminals of the driving device to input terminals of y negative polarity DAC circuits, and connecting output terminals of y negative polarity DAC circuits to the y output terminals in the N output terminals. Wherein, the y output terminals are spaced y output terminals in the N output terminals.

15. The method according to claim 14, wherein, the device further includes:
in the DAC array, x positive polarity DAC circuits are adjacent, y negative polarity DAC circuits are adjacent, N is an integer multiple of a sum of x and y.

16. The method according to claim 2, wherein,
the driving device includes N output terminal, the step of building a first signal transmission channel group including N signal transmission channels includes:
connecting x input terminals of the driving device to input terminals of x positive polarity DAC circuits, connecting output terminals of x positive polarity DAC circuits to x output terminals of the driving device, wherein the x output terminals are adjacent x output terminals in the N output terminals;
connecting y input terminals of the driving device to input terminals of y negative polarity DAC circuits, and connecting output terminals of y negative polarity DAC circuits to the y output terminals of the driving device, wherein, the y output terminals are adjacent y output terminals in the N output terminals.

17. The device according to claim 7, wherein, the first building module includes:
a first adjacent connection unit for connecting x input terminals of the driving device to input terminals of x positive polarity DAC circuits, connecting output terminals of x positive polarity DAC circuits to x output terminals of the driving device, wherein, the driving device includes N output terminals, and the x output terminals are adjacent x output terminals in the N output terminals;
a second connection unit for connecting y input terminals of the driving device to input terminals of y negative polarity DAC circuits, and connecting output terminals of y negative polarity DAC circuits to the y output terminals of the driving device, wherein, the y output terminals are adjacent y output terminals in the N output terminals.

18. The device according to claim 12, wherein, the device further includes a first multiplexer, a second multiplexer and a DAC array, wherein, the first signal transmission channel group including N signal transmission channels for N image signals built by the processor includes:
using the first multiplexer to connect x input terminals of the driving device to input terminals of x positive polarity DAC circuits, using the second multiplexer to connect output terminals of x positive polarity DAC circuits to x output terminals of the driving device, wherein, the driving device includes N output terminals, and the x output terminals are adjacent x output terminals in the N output terminals;
using the first multiplexer to connect y input terminals of the driving device to input terminals of y negative polarity DAC circuits, and using the second multiplexer to connect output terminals of y negative polarity DAC circuits to the y output terminals of the driving device, wherein, the y output terminals are adjacent y output terminals in the N output terminals.
